(19) United States
(12) Patent Application Publication
(10) Pub. No.: US 2026/0108982 A1
(43) Pub. Date: Apr. 23, 2026

(54) LASER MACHINE AND LASER MACHINING METHOD

(71) Applicants: MEERE COMPANY INC., Hwaseong-si Gyeonggi-do (KR); SAMSUNG ELECTRONICS CO., LTD., Suwon-si Gyeonggi-do (KR)

(72) Inventors: Joon Jung LEE, Anyang-si Gyeonggi-do (KR); Dae Young LEE, Pyeongtaek-si Gyeonggi-do (KR); Kyungsoon PARK, Asan-si Chungcheongnam-do (KR); Hyuckjun YOO, Asan-si Chungcheongnam-do (KR); Byonggook JEONG, Asan-si Chungcheongnam-do (KR)

(73) Assignees: MEERE COMPANY INC., Hwaseong-si Gyeonggi-do (KR); SAMSUNG ELECTRONICS CO., LTD., Suwon-si Gyeonggi-do (KR)

(21) Appl. No.: 19/361,251

(22) Filed: Oct. 17, 2025

(30) Foreign Application Priority Data
Oct. 22, 2024 (KR) 10-2024-0145245
Jan. 22, 2025 (KR) 10-2025-0009311

(51) Int. Cl. B23K 26/06; B23K 26/067; B23K 26/364; B23K 101/40

(52) U.S. Cl. CPC B23K 26/0648; B23K 26/0676; B23K 26/364; B23K 2101/40

(57) ABSTRACT

A laser machine includes at least one laser oscillator configured to output a laser beam, at least one beam control element configured to control a shape of the laser beam output from the laser oscillator, at least one lens arranged between the beam control element and a workpiece and configured to control a size of the laser beam, the shape of which is controlled by the beam control element, and irradiate the size-controlled laser beam onto the workpiece, and a controller configured to set a machining line width to be formed on the workpiece, determine a rotation angle of the beam control element according to the set machining line width, and control the beam control element to be rotated around a rotation axis parallel to a normal line of a plane of the workpiece according to the determined rotation angle.

### CROSS-REFERENCE TO RELATED APPLICATIONS

This application claims priority under 35 U.S.C. § 119 to Korean Patent Application No. 10-2024-0145245, filed on Oct. 22, 2024, and Korean Patent Application No. 10-2025-0009311, filed on Jan. 22, 2025, in the Korean Intellectual Property Office, the disclosure of which is incorporated by reference herein in its entirety.

### BACKGROUND

### 1. Field

The disclosure relates to a laser machine for use in semiconductor device machining and a laser machining method using the laser machine.

### 2. Description of the Related Art

When machining semiconductor devices, laser patterning may be performed to precisely form desired patterns on a workpiece by using a laser. Furthermore, laser grooving may be performed to form precise grooves on the workpiece during semiconductor chip dicing or chip packaging processes.

In a laser machine which performs laser machining, the shapes of laser beams to be irradiated onto a workpiece have to be changed according to the type of workpiece to be laser-machined, the specifications and shape of the form to be machined, processing methods, or the like. To this end, the type and size of an optical unit included in the laser machine also have to be changed.

However, changing the optical unit according to various machining specifications has technical limitations and also causes a decrease in production yield, a deterioration in machining quality, an increase in machining defects, and cost issues. This is because the configuration of the optical unit is very complicated, and in case that a plurality of components included in the optical unit are changed and manipulated so as to satisfy various machining specifications, problems such as a deterioration in machining quality and machining defects occur due to aberrations caused by the plurality of components included in the optical unit, which lowers the production yield.

### SUMMARY

The disclosure provides a laser machine for controlling a machining line width of a workpiece by rotating a beam control element in semiconductor device machining and a laser machining method using the laser machine. The objectives to be achieved by the disclosure are not limited to those described above, and other objectives may be inferred from the following embodiments.

According to an aspect of the disclosure, provided is a laser machine for machining a workpiece, the laser machine including at least one laser oscillator configured to output a laser beam, at least one beam control element configured to control a shape of the laser beam output from the at least one laser oscillator, at least one lens arranged between the at least one beam control element and the workpiece and configured to control a size of the laser beam, the shape of which is controlled by the at least one beam control element, and irradiate the size-controlled laser beam onto the workpiece, and a controller configured to set a machining line width to be formed on the workpiece, determine a rotation angle according to the set machining line width, and control the at least one beam control element to be rotated around a rotation axis parallel to a normal line of a plane of the workpiece according to the determined rotation angle.

The at least one beam control element may include a one-dimensional diffractive optical element configured to split the laser beam into a plurality of branched beams in a one-dimensional array, and the controller may be further configured to determine the rotation angle, based on radii of curvature of branched beams having passed through the at least one lens and a gap between adjacent branched beams having passed through the at least one lens.

In case that a parallel axis (Lt) parallel to a direction in which the plurality of branched beams are linearly arranged and a reference axis (As) parallel to a machining direction crossing the machining line width are defined, the rotation angle may be selected within a range from 0°, which corresponds to a case where the parallel axis (Lt) is parallel to the reference axis (As), to an acute angle formed between the parallel axis (Lt) and the reference axis (As).

The at least one beam control element may include a linear beam generation diffractive optical element configured to control the laser beam into a linear beam.

The at least one beam control element may include a cylindrical lens configured to control the laser beam into a linear beam.

In case that a parallel axis (Lt) parallel to the linear beam and a reference axis (As) parallel to a machining direction crossing the machining line width are defined, the rotation angle may be selected within a range from 0°, which corresponds to a case where the parallel axis (Lt) is parallel to the reference axis (As), to 90°, which corresponds to a case where the parallel axis (Lt) is perpendicular to the reference axis (As).

The laser machine may further include a beam limiting element arranged between the at least one beam control element and the at least one lens and configured to block a portion of the laser beam, the shape of which is controlled by the at least one beam control element.

The beam limiting element may include a slit or an aperture.

The controller may be further configured to determine a beam blocking range, based on the rotation angle.

The at least one lens may include an objective lens.

The controller may be further configured to control a size of the machining line width by controlling magnification through changing a focal length of the at least one lens.

According to another aspect of the disclosure, provided is a laser machining method, performed by a laser machine, of machining a workpiece, wherein the laser machine is configured to cause a laser oscillator to output a laser beam, cause a beam control element to control a shape of the output laser beam, and control a size of the laser beam, the shape of which is controlled by a lens, and irradiate the size-controlled laser beam onto the workpiece, wherein a controller is configured to set a machining line width to be formed on the workpiece, determine a rotation angle of the beam control element according to the set machining line width, and control the beam control element to be rotated around a rotation axis parallel to a normal line of a plane of the workpiece according to the determined rotation angle.

According to the disclosure, various machining processes may be performed by controlling the machining line width without changing the optical unit included in the laser machine.

The linear arrangement direction of the laser beam irradiated onto the workpiece may be controlled simply by rotating the beam control element even with only one optical unit, which enables the workpiece to be machined from a narrow range to a wide range.

Furthermore, various machining specifications may be satisfied without changing the optical unit, which contributes to simplifying and stabilizing process conditions.

### BRIEF DESCRIPTION OF THE DRAWINGS

The above and other aspects, features, and advantages of certain embodiments of the disclosure will be more apparent from the following description taken in conjunction with the accompanying drawings in which:

FIG. 1 is a diagram illustrating a laser machine according to an embodiment;

FIG. 2 is a flowchart illustrating a laser machining method using the laser machine of FIG. 1;

FIGS. 3A, 3B, and 3C are explanatory diagrams illustrating a laser machining method in case that a beam control element is a one-dimensional diffractive optical element (1D DOE) which splits a laser beam into a plurality of branched beams in a one-dimensional array;

FIGS. 4A and 4B are explanatory diagrams illustrating a laser machining method in case that the beam control element is a linear beam generation DOE;

FIGS. 5A and 5B are explanatory diagrams illustrating a laser machining method in case that the beam control element is a cylindrical lens;

FIG. 6 shows images obtained by capturing a workpiece machined at rotation angles determined by a controller in case that the beam control element of FIGS. 3A, 3B, and 3C is a 1D DOE;

FIG. 7 is an explanatory diagram illustrating an operation in which the controller sets a rotation angle in case that the beam control element of FIGS. 3A, 3B, and 3C is a 1D DOE;

FIG. 8 is a diagram illustrating a laser machine according to another embodiment; and

FIGS. 9A and 9B are explanatory diagrams illustrating a laser machining method using a laser machine including a beam limiting element.

### DETAILED DESCRIPTION

Hereinafter, embodiments of the disclosure will be described with reference to the accompanying drawings, so that those of ordinary skill in the art may easily carry out the disclosure. However, the disclosure may be implemented in various different forms and is not limited to embodiments described herein. To clearly explain the disclosure, parts irrelevant to the description are omitted in the drawings and similar reference numerals are assigned to similar parts throughout the specification.

In the following embodiments, the terms “first,” “second,” etc. are not used in a restrictive sense and are used to distinguish one element from another.

The singular forms as used herein are intended to include the plural forms as well unless the context clearly indicates otherwise.

It will be understood that the terms “include” and/or “comprise” as used herein specify the presence of stated features or elements, but do not preclude the presence or addition of one or more other features or elements.

In the following embodiments, it will be understood that, when a portion such as layer, region, or element is referred to as being “on” another portion, this may include not only a case where the portion is directly on the other portion, but also a case where intervening layers, regions, or elements may be present therebetween.

Furthermore, sizes of elements in the drawings may be exaggerated or reduced for convenience of explanation. For example, because sizes and thicknesses of elements in the drawings are arbitrarily illustrated for convenience of explanation, the disclosure is not necessarily limited thereto.

The x-axis, the y-axis, and the z-axis are not limited to three axes of the rectangular coordinate system and may be interpreted in a broader sense. For example, the x-axis, the y-axis, and the z-axis may be perpendicular to one another or may represent different directions which are not perpendicular to one another.

In case that a certain embodiment is implemented differently, a specific process sequence may be performed differently from a sequence described herein. For example, two consecutively described processes may be performed substantially at the same time or performed in an order opposite to the stated order.

Hereinafter, the disclosure will be described in detail with reference to the accompanying drawings.

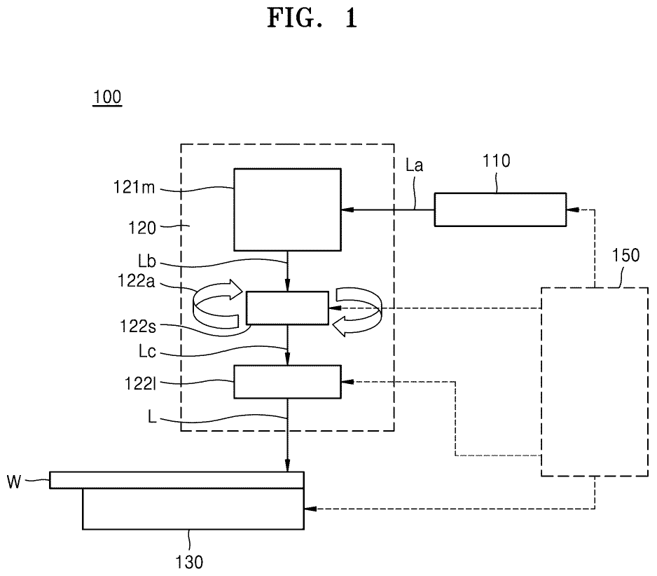

FIG. 1 is a diagram illustrating a laser machine 100 according to an embodiment.

Referring to FIG. 1, the laser machine 100 may include at least one laser oscillator 110, at least one optical unit 120, a machining table 130, and a controller 150.

The laser oscillator 110 may include a laser source which generates and outputs a laser beam having a particular wavelength. The type of laser beam output from the laser oscillator 110 is not particularly limited and may be appropriately selected depending on the type or machining method of a workpiece W. For example, the laser beam output from the laser oscillator 110 may be any one of a solid laser beam including a ruby laser beam, a neodymium (Nd):yttrium aluminum garnet (YAG) laser beam, a titanium (Ti):sapphire laser beam, or the like, a liquid laser beam including a dye laser beam or the like, a gas laser beam including a carbon dioxide (CO₂) laser beam, a helium (He)-neon (Ne) laser beam, an argon ion (Ar+) laser beam, an excimer laser beam, or the like, and an ultraviolet (UV) laser beam. The laser oscillator 110 may be connected to the controller 150. Characteristics of the laser beam output from the laser oscillator 110, for example, the output power, intensity, period, output timing, and the like of the laser beam, may be controlled by signals generated by the controller 150.

The machining table 130 may be arranged opposite the irradiation direction of the laser beam. The workpiece W may be seated on the machining table 130. The machining table 130 may be movable in a set direction. For example, the machining table 130 may be movable in the X-axis, Y-axis, and Z-axis directions. The operation of the machining table 130, for example, the moving speed, moving direction, moving distance, or the like of the machining table 130, may be controlled by the controller 150. The machining table 130 may include a rotating rotary stage.

The optical unit 120 may include at least one mirror 121m, at least one beam control element 122s, and at least one lens 122l. The optical unit 120 may control an optical path of a laser beam La output from the laser oscillator 110, so as to irradiate a laser beam L onto a desired position on the workpiece W. In some embodiments, the operation and position of the optical unit 120 may be controlled by the controller 150.

The mirror 121m may control the optical path of the laser beam La output from the laser oscillator 110. The number of mirrors 121m included in the laser machine 100 is not particularly limited, and the mirrors 121m may be galvano mirrors. The mirror 121m may be controlled by the controller 150.

The beam control element 122s may be arranged between the mirror 121m and the lens 122l. The beam control element 122s may control the shape of the laser beam Lb which is output from the laser oscillator 110 and of which the optical path is set. The beam control element 122s may control the shape and distribution of the laser beam so as to form a particular pattern. The beam control element 122s may be a beam shaping element. The beam control element 122s may be an element which changes the shape of the laser beam to be approximately linear. The terms “approximately linear” may include not only a case where the laser beam is linear, but also a case where the laser beam includes a set of a plurality of branched beams arranged linearly.

In an embodiment, the beam control element 122s may be a one-dimensional diffractive optical element (1D DOE) which splits a laser beam into a plurality of branched beams in a 1D array. In another embodiment, the beam control element 122s may be a linear beam generation DOE which controls a laser beam into a linear beam. For example, the beam control element 122s may be a flat top line beam DOE. In another embodiment, the beam control element 122s may be a cylindrical lens which controls a laser beam into a linear beam. The cylindrical lens may include a cylindrical concave lens, a cylindrical convex lens, or the like, but the disclosure is not limited thereto. Embodiments are not limited thereto, and any element may be used as the beam control element 122s as long as the element is capable of controlling a laser beam to be approximately linear.

The beam control element 122s may be rotated around a rotation axis parallel to a normal line (a vertical axis) of the plane of the workpiece W. For example, the controller 150 may control the beam control element 122s to be rotated around the rotation axis by a rotation angle (0). The rotation axis may be parallel to the normal line of the plane of the workpiece W. In some embodiments, the rotation axis may refer to an axis which is parallel to a normal line of the surface of the workpiece W and is located at the center of the beam control element 122s. The beam control element 122s may be rotated to change the linear arrangement direction of the laser beam to be irradiated onto the workpiece W.

The controller 150 may control the respective components of the laser machine 100. The controller 150, which acts as a processor, may be implemented by including at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electrical units for performing functions.

According to an embodiment, the controller 150 may set a machining line width to be formed on the workpiece W, may determine the rotation angle (0) according to the set machining line width, and may control the beam control element 122s to be rotated by the determined rotation angle (0). A specific operation of the controller 150 is described below.

The lens 122l may be arranged between the machining table 130 and the mirror 121m. The lens 122l may focus a laser beam Lc, the shape of which has been controlled by passing through the beam control element 122s. The lens 122l may control the size of the shape-controlled laser beam Lc and may irradiate the size-controlled laser beam L onto the workpiece W. In an embodiment, the lens 122l may be at least one objective lens. However, the lens 122l may include, in addition to the at least one objective lens, any lens capable of focusing a laser beam, such as a telecentric lens, an f-theta lens, or a focusing lens. Although one lens 122l is illustrated, a plurality of lenses 122l may be included. For example, the lens 122l may include a plurality of spherical lenses or flat lenses.

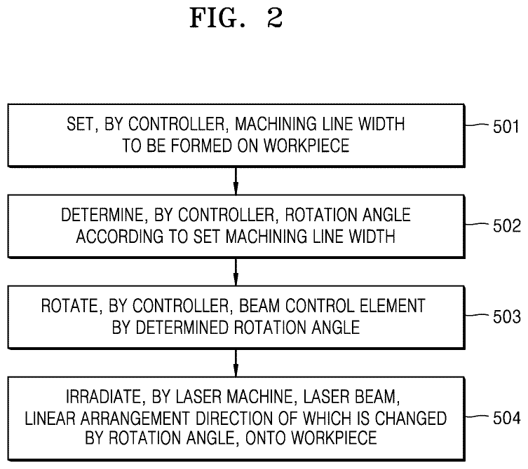

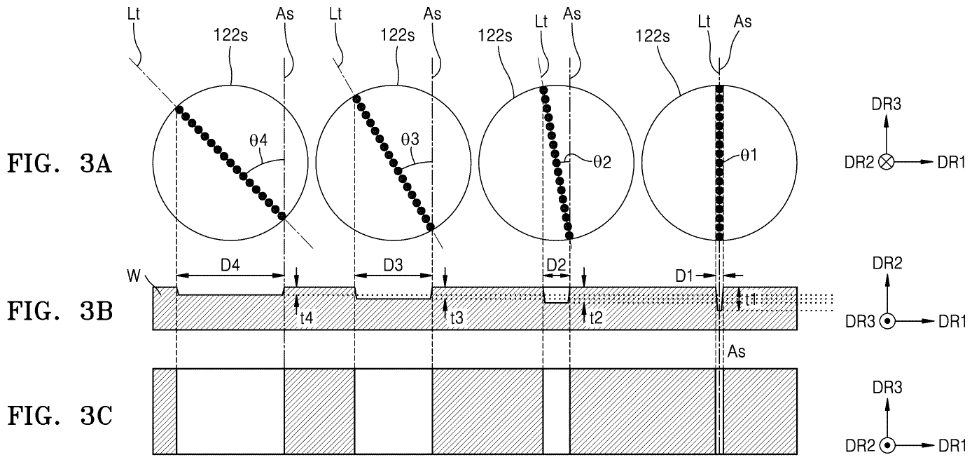

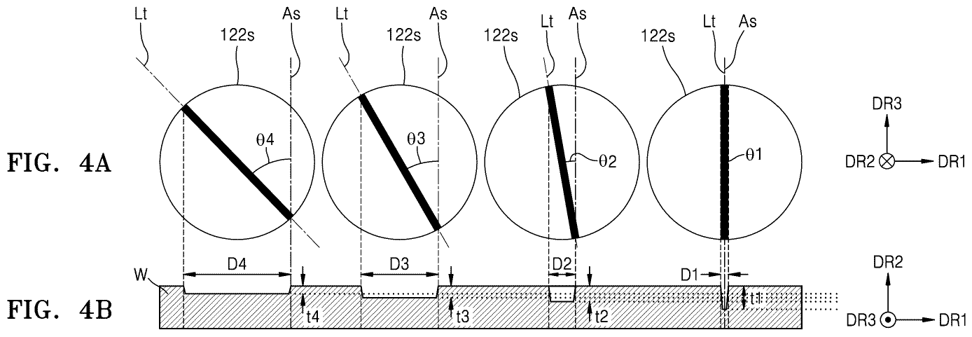

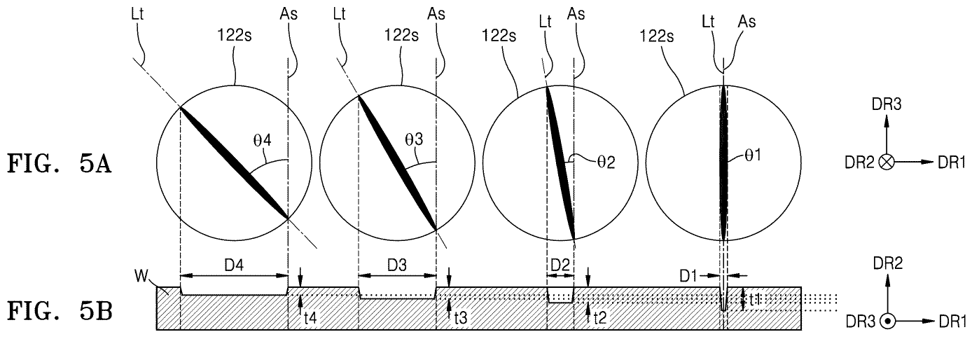

FIG. 2 is a flowchart illustrating a laser machining method using the laser machine 100 of FIG. 1. FIGS. 3A and 3B are explanatory diagrams illustrating a laser machining method in case that the beam control element 122s is a 1D DOE which splits a laser beam into a plurality of branched beams in a 1D array. FIG. 4 is an explanatory diagram illustrating a laser machining method in case that the beam control element 122s is a linear beam generation DOE. FIG. 5 is an explanatory diagram illustrating a laser machining method in case that the beam control element 122s is a cylindrical lens. FIG. 3A, FIG. 4A, and FIG. 5A are plan views of the rotating beam control element 122s, and FIG. 3B, FIG. 4B, and FIG. 5B are cross-sectional views of the workpiece W. FIG. 3C is a plan view of the workpiece W.

Referring to FIG. 2, in operation 501, the controller 150 may set a machining line width to be formed on the workpiece W. The machining line width may refer to a width of an area to be laser-machined by a laser beam formed on the surface of the workpiece W in a laser machining process. For example, as illustrated in FIGS. 3A to 5B, the machining line width may refer to widths D1, D2, D3, and D4 of a machining area in a first direction DR1 where the workpiece W is machined according to the linear arrangement direction of the laser beam changed due to the rotation of the beam control element 122s. The first direction DR1 may be a direction crossing a second direction DR2 in which the laser beam is irradiated onto the workpiece W in a cross-sectional view of the workpiece W, and may be a direction crossing a third direction DR3 which is the machining direction of the laser beam in a plan view of the workpiece W.

The controller 150 may set the machining line width, based on the machining shape of the workpiece W and the size of the machining area. For example, in case that the machining shape of the workpiece W and the size of the machining area are input to the controller 150, the controller 150 may set the machining line width through a table in which the machining line width is predetermined and mapped according to the machining shape of the workpiece W and the size of the machining area. The machining line width may also be set by taking into account a material and thickness of the workpiece W and a desired machining depth as additional parameters. However, the disclosure is not limited thereto and the machining line width may also be set according to a user input.

In operation 502, the controller 150 may determine the rotation angle (θ) of the beam control element 122s according to the machining line width. The rotation angle (θ) may refer to an angle at which the beam control element 122s located opposite the surface of the workpiece W is rotated with respect to the workpiece W. The rotation angle (θ) may be defined based on a positional relationship between the workpiece W and the laser beam to be irradiated onto the workpiece W. Referring to FIGS. 3A, 3B, and 3C, the rotation angle (θ) may refer to an angle formed between a parallel axis Lt parallel to a direction in which the branched beams are linearly arranged and a reference axis As parallel to a machining direction (the third direction DR3) crossing the machining line width in case that the laser beam irradiated onto the workpiece W has the narrowest machining line width with respect to the workpiece W. Referring to FIGS. 4A, 4B, 5A and 5B, the rotation angle (θ) may refer to an angle formed between a parallel axis Lt parallel to a linear beam and a reference axis As parallel to a machining direction (the third direction DR3) crossing the machining line width in case that the laser beam irradiated onto the workpiece W has the narrowest machining line width with respect to the workpiece W. In other words, in the disclosure, in case that the parallel axis Lt is parallel to the reference axis As, the rotation angle (θ) may be defined as 0 degrees (0°), and in case that the parallel axis Lt is perpendicular to the reference axis As, the rotation angle (θ) may be defined as 90°. In an embodiment, the rotation angle (θ) may be selected between 0°, which corresponds to a case where the parallel axis Lt is parallel to the reference axis As, and 90°, which corresponds to a case where the parallel axis Lt is perpendicular to the reference axis As.

In some embodiments, the beam control element 122s may be rotated to change the linear arrangement direction of the laser beam irradiated onto the workpiece W. The rotation angle (θ) may be defined as a first angle in case that the linear arrangement direction of the laser beam corresponds to the machining of the narrowest machining line width, and may be defined as a second angle in case that the linear arrangement direction of the laser beam corresponds to the machining of the widest machining line width. The first angle may be about 0° and the second angle may be about 90°, but the disclosure is not limited thereto.

In an embodiment, the controller 150 may include a table in which the rotation angle (θ) corresponding to the machining line width is mapped according to the beam control element 122s, and may determine the rotation angle (θ) according to the set machining line width.

In another embodiment, the controller 150 may further input the type of the beam control element 122s as an additional parameter, may include, in the table, a rotation angle (θ) corresponding to a machining line width according to the type of the beam control element 122s, and may determine the rotation angle (θ) according to the type of the selected beam control element 122s and the set machining line width. For example, Table 1 is an example table showing the matching of the rotation angle (θ) according to the machining line width in case that the beam control element 122s is a 1D DOE which splits the laser beam into a plurality of branched beams in a 1D array. Radii of curvature of individual branched beams may be 5 micrometers, and a gap between adjacent branched beams may be 0.13°.

TABLE 1

| Machining line width | |
|---|---|
| (micrometers, μm) | Rotation angle (degrees, °) |
| 5.00 | 0 |
| 8.90 | 1 |
| 12.80 | 2 |
| 16.69 | 3 |
| 20.58 | 4 |
| 24.47 | 5 |
| 28.35 | 6 |
| 32.23 | 7 |

In another embodiment, the controller 150 may determine the rotation angle (θ), based on the set machining line width and the length of the linear beam having passed through the lens 122l. The length of the linear beam may be the total length of the linear beam having passed through the lens 122l in a linear axis direction, and may be the distance between two end points where the central intensity of the laser beam begins to decrease below a certain level (e.g., 1/e² or about 50% intensity, where e corresponds to a base of a natural logarithm). The rotation angle (θ) may be expressed as Equation 1 by using trigonometry based on the machining line width (D) and the total length (X) of the linear beam having passed through the lens 122l.

$$θ = {sin}^{- 1} \frac{D}{X} \qquad [ Equation 1 ]$$

The method, performed by the controller 150, of determining the rotation angle from the machining line width, is not limited to the embodiments described above and may be variously modified by using, for example, an artificial intelligence model trained through training data.

The controller 150 may determine a smaller rotation angle (θ) (a rotation angle close to about 0°) as the machining line width becomes narrower, and may determine a larger rotation angle (θ) (a rotation angle close to about 90°) as the machining line width becomes wider. This is because the linear arrangement direction of the laser beam changes depending on the rotation angle, and thus, the machining line width changes, and the energy density of the laser beam irradiated onto the workpiece changes depending on a change in the linear arrangement direction of the laser beam, and thus, the machining depth changes.

FIGS. 3A to 5B illustrate machining line widths D1, D2, D3, and D4 and machining depths t1, t2, t3, and t4 according to the rotation angles θ1, θ2, θ3, and θ4 of the beam control element 122s.

Referring to the drawings, it may be confirmed to have the narrowest first machining line width D1 and the deepest first machining depth t1 at the first rotation angle θ1 of 0°. It may be confirmed to have the second machining line width D2 wider than the first machining line width D1 and the second machining depth t2 shallower than the first machining depth t1 at the second rotation angle θ2 greater than the first rotation angle θ1, may have the third machining line width D3 wider than the second machining line width D2 and the third machining depth t3 shallower than the second machining depth t2 at the third rotation angle θ3 greater than the second rotation angle θ2, and may have the fourth machining line width D4 wider than the third machining line width D3 and the fourth machining depth t4 shallower than the third machining depth t3 at the fourth rotation angle θ4 greater than the third rotation angle θ3.

Referring again to FIG. 2, in operation 503, the controller 150 may control the beam control element 122s to be rotated by the determined rotation angle (θ). In operation 504, the laser machine 100 may irradiate the laser beam, the linear arrangement direction of which is changed by the rotation of the beam control element 122s, onto the workpiece W. As a result, the workpiece W may be machined to the machining line width and machining depth corresponding to the laser beam, the linear arrangement direction of which is controlled according to the rotation angle (θ).

According to the embodiments, the laser machine 100 may control the machining line width on the workpiece W by controlling the linear arrangement direction of the laser beam irradiated onto the workpiece W without changing the lens 122l. Simply by rotating the beam control element 122s, the machining line width of the workpiece W may be controlled to be narrow or wide, which enables the workpiece W to be machined quickly and easily according to various machining specifications.

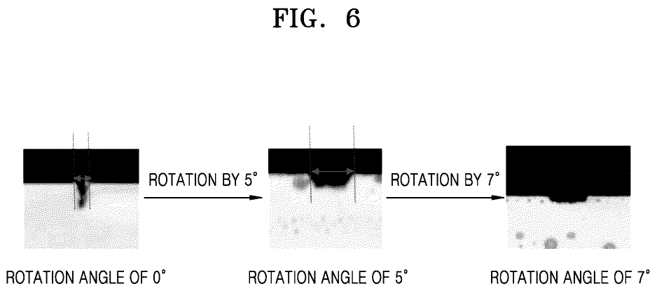

FIG. 6 shows images obtained by capturing the workpiece W machined at the rotation angles (θ) determined by the controller 150 in case that the beam control element 122s of FIG. 3A is a 1D DOE.

In the case of the 1D DOE of FIG. 3, the shape of the laser beam is not controlled to be continuously linear, unlike the beam control elements of FIGS. 4A, 4B, 5A and 5B. Therefore, when the beam control element 122s is a 1D DOE, the controller 150 has to specifically control the rotation angle so that the laser beam is approximately linearly irradiated onto the workpiece W. In case that the laser beam Lb output from the laser oscillator 110 passes through the 1D DOE, the laser beam Lb may be split into a plurality of branched beams in a 1D array rather than a continuous linear beam. The size of each of the split branched beams may be controlled through the lens 122l having a certain focal length. Even in case that the laser beam is a set of a plurality of branched beams in a 1D array, the controller 150 may control the rotation angle within a certain range so as to provide an effect similar to the irradiation of the approximately linear beam onto the workpiece W.

The range of the rotation angle in case that the beam control element 122s is the 1D DOE may be smaller than the range of the rotation angle of the beam control element 122s which irradiates the linear beam (e.g., the linear beam generation DOE). For example, in case that the beam control element 122s is the 1D DOE, the rotation angle may be selected within a range from 0°, which corresponds to a case where the parallel axis Lt is parallel to the reference axis As, to an acute angle formed between the parallel axis Lt and the reference axis As. In case that the beam control element 122s is the 1D DOE, the controller 150 may determine the rotation angle based on a minimum overlap angle of the branched beams. Details thereof are described below.

In an embodiment, in case that the beam control element 122s is the 1D DOE, a gap between the branched beams may change according to the rotation angle (θ) of the beam control element 122s. The controller 150 may select the rotation angle (θ) of the beam control element 122s within a range from an angle at which a gap between the branched beams disappears due to the rotation of the beam control element 122s, and thus, the branched beams completely overlap each other, to an angle at which a gap between the branched beams narrows, and thus, the overlap between the branched beams begins. In other words, in case that the rotation angle (θ) is outside the above range, a gap between the branched beams incident on the workpiece W may increase, which may cause a problem in that the workpiece W is not uniformly machined within a certain machining line width.

Referring to FIG. 6, in case that the beam control element 122s is the 1D DOE, the images of actual machining results of the workpiece W may be confirmed for cases where the rotation angle (θ) is 0°, 5°, and 7° in order from left to right. Accordingly, it may be confirmed that the workpiece W is uniformly machined according to a certain line width when the rotation angle (θ) is within a range of 0° to 7°. In some embodiments, in the case of the rotation angles of 0° and 5° at which the magnifications of images are equal to each other, it may be confirmed that the machining line width when the rotation angle is 5° is wider than the machining line width when the rotation angle is 0°. Because the magnification of the image when the rotation angle is 7° is different from the magnifications of the images when the rotation angles are 0° and 5°, the size of the machining line width is not compared with the case where the rotation angles are 0° and 5°.

Hereinafter, a specific method, performed by the controller 150, of setting the rotation angle (θ) in case that the beam control element 122s is a 1D DOE is described.

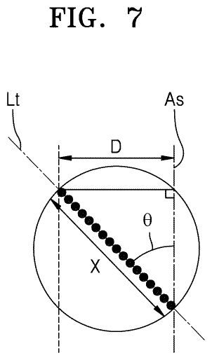

FIG. 7 is an explanatory diagram illustrating an operation in which the controller 150 sets the rotation angle (θ) in case that the beam control element 122s of FIG. 3A is a 1D DOE.

Referring to FIG. 7, the controller 150 may determine the rotation angle (θ) according to the set machining line width, based on the minimum overlap angle of the branched beams. The minimum overlapping angle may refer to an angle at which the overlap between the branched beams begins. The minimum overlap angle may correspond to the maximum value of the rotation angle (θ). This is because a gap between the branched beams widens at the rotation angle (θ) exceeding the minimum overlap angle, making it impossible to uniformly machine the workpiece W. The minimum overlap angle may be determined based on a radius of curvature (d₀) of the branched beam having passed through the lens 122l and a gap (Δx) between adjacent branched beams having passed through the lens 122l. For example, the minimum overlap angle (θm) may be determined as in Equation 2 below, based on the radius of curvature (d₀) of the branched beam having passed through the lens 122l and the gap (Δx) between adjacent branched beams having passed through the lens 122l.

$${θ}_{m} = {sin}^{- 1} ( \frac{{d}_{0}}{{d}_{0} + \frac{( Δ x - 2 {d}_{0} )}{2}} ) \qquad [ Equation 2 ]$$

When it is assumed that the branched beam having passed through the lens 122l is approximately circular, a radius of curvature (d₀) of the individual branched beam arriving at the workpiece W may be derived through a diameter (2d₀) of the individual branched beam. The radius of curvature (d₀) of the individual branched beam may be half the diameter of the individual branched beam. The diameter (2d₀) of the individual branched beam may be determined by a wavelength (λ) of the laser beam, a focal length (F) of the lens, a diameter (DD) of the laser beam incident on the lens, and a quality factor (M²) of the laser beam, as expressed in Equation 3 below. The quality factor (M²) of the laser beam is an index indicating how close the laser beam is to an ideal Gaussian beam.

$$2 {d}_{0} = ( \frac{4 λ}{π} ) ( \frac{F}{DD} ) {M}^{2} \qquad [ Equation 3 ]$$

A gap (Δx) between adjacent branched beams may be obtained as in Equation 4, based on trigonometric function values of a focal length (F) of the lens and a diffraction angle (θₛ) of the branched beam.

$$Δ x = F tan {θ}_{s} \qquad [ Equation 4 ]$$

The diffraction angle (θₛ) of the branched beam may be obtained as in Equation 5 below, based on a diffraction order (m), a wavelength (λ) of a laser beam, and a grating period (d) of a 1D DOE through a diffraction grating equation.

$$sin {θ}_{s} = m \frac{λ}{d} \qquad [ Equation 5 ]$$

In an embodiment, it is assumed that the 1D DOE forms six branched beams and the 1D DOE is combined with a lens having a focal length of 20 mm. The diffraction angle (θₛ) of the branched beam may be determined to be 0.13 by Equation 5 above, based on the given diffraction order and the given wavelength of the laser beam. The gap (Δx) between the branched beams having passed through the lens may be determined to be 46.77 micrometers by Equation 4 above. The radius of curvature (d₀) of the branched beam having passed through the lens may be determined to be 2.5 micrometers by Equation 3 above. The minimum overlap angle of the branched beams may be calculated to be 6.14° by Equation 6, which substitutes the determined values into Equation 2. In other words, the controller 150 may set the maximum value of the rotation angle (θ) to 6.14°.

$${θ}_{m} = {sin}^{- 1} ( \frac{2.5}{2.5 + \frac{( 46.77 - 5 )}{2}} ) \qquad [ Equation 6 ]$$

In the embodiment described above, because the beam control element 122s is the 1D DOE, even in case that the laser beam is split into a plurality of branched beams, the controller 150 may derive a rotation angle (θ) for uniform laser machining within a machining line width, thereby maintaining a constant machining quality and preventing machining defects.

According to another embodiment, the controller 150 may control the size of the machining line width by controlling magnification through changing the focal length of the lens 121l, as well as the method of rotating the beam control element 122s. The controller 150 may control a position of a focus by controlling a distance between the lens 121l and the workpiece W. In this case, the workpiece W may be moved while the lens 121l is fixed, or the lens 121l may be moved while the workpiece W is fixed. In some embodiments, because the laser machine 100 may include at least one lens 121l, the controller 150 may control the total focal length or magnification by changing positions between lenses in a multi-lens array. For example, in case that the focal length is controlled from the lens 121l with a focal length of 20 mm to the lens 121l with a focal length of 40 mm, the diameter of the branched beam having passed through the lens 121l may double and the size of the machining line width may also double.

According to the embodiment described above, because the rate of change in the machining line width may be controlled by changing the focal length of the lens 121l, the laser machine 100 may precisely control the machining line width and respond to various machining designs, thereby improving the efficiency of production.

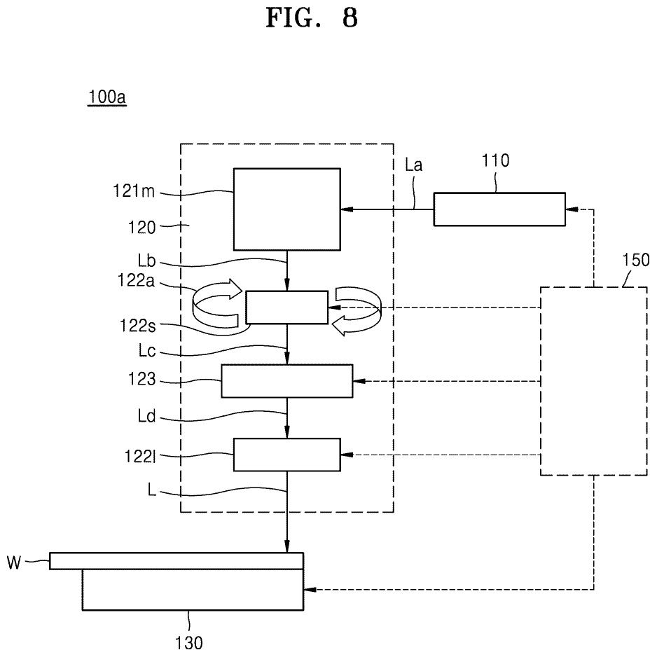

FIG. 8 is a diagram illustrating a laser machine 100 according to another embodiment. The laser machine according to the embodiment of FIG. 8 differs from the embodiment of FIG. 1 in that an optical unit 120 further includes a beam limiting element 123. Because the other components are identical to those of the embodiment of FIG. 1, redundant descriptions thereof are omitted.

The beam limiting element 123 may be arranged between a beam control element 122s and a lens 122l. The beam limiting element 123 may generate a partially blocked laser beam Ld by blocking a portion of a laser beam Lc, the shape of which is controlled by the beam control element 122s. The beam limiting element 123 may be a slit or an aperture, but the disclosure is not limited thereto, and any element may be used as the beam limiting element 123 as long as the element is capable of blocking a portion of the laser beam.

A controller 150 may control the beam limiting element 123 to control a laser beam blocking ratio of the beam limiting element 123, based on a rotation angle (θ), so as to machine a workpiece W to a constant machining depth, despite the rotation angle (θ) of the beam control element 122s. In some embodiments, the controller 150 may control the beam limiting element 123 in synchronization with the rotation angle (θ).

For example, the controller 150 may control the beam limiting element 123 to increase the laser beam blocking ratio as the size of the rotation angle (θ) decreases (closer to 0°), and to decrease the laser beam blocking ratio as the size of the rotation angle (θ) increases (closer to 90°). In other words, the controller 150 may increase the laser beam blocking ratio as the set machining line width becomes narrower, and may decrease the laser beam blocking ratio as the set machining line width becomes wider, thereby machining the workpiece W to a uniform machining depth.

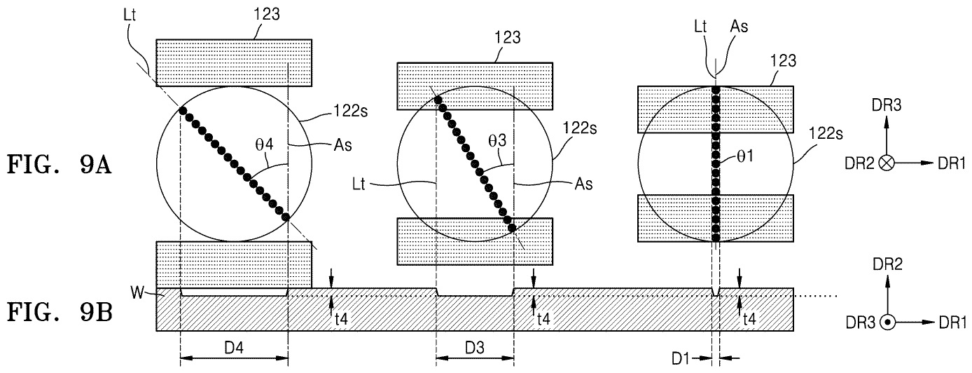

FIGS. 9A and 9B are explanatory diagrams illustrating a laser machining method using the laser machine 100 including the beam limiting element 123. FIGS. 9A and 9B illustrate a case where the beam control element 122s is a 1D DOE, but the disclosure is not limited thereto, and the laser machining method of the disclosure may also be used when the beam control element 122s is a linear beam generation DOE, a cylindrical lens, or the like. Similar to FIGS. 3A, 3B, and 3C, FIG. 9A is a plan view of the rotating beam control element 122s and the beam limiting element 123, and FIG. 9B is a cross-sectional view of the workpiece W. The following description is given with reference to FIGS. 3A, 3B, 3C, 9A and 9B.

Referring again to FIGS. 3A, 3B, and 3C, the workpiece W may be machined to a second machining line width D2 wider than a first machining line width D1 and a second machining depth t2 shallower than a first machining depth t1 at a second rotation angle θ2 greater than a first rotation angle θ1. The power and machining speed of the laser beam may be constant, but in case that the linear arrangement direction of the laser beam changes, the machining line width may narrow and the energy density per unit area of the laser beam transmitted to the narrowed machining line width may increase.

Referring to FIGS. 9A and 9B, the controller 150 may control the laser beam blocking ratio of the beam limiting element 123 in synchronization with the rotation angle (θ) of the beam control element 122s, thereby maintaining the energy density per unit area of the laser beam transmitted to the workpiece W constant. Accordingly, the laser machine 100 may maintain a constant machining depth even in case that the workpiece W is machined to various machining line widths. In FIGS. 9A and 9B, it may be confirmed that the machining depth at each of a first rotation angle θ1, a third rotation angle θ3, and a fourth rotation angle θ4 is equal to a fourth machining depth t4, but the machining line widths for the rotation angles θ1, θ3, and θ4 are respectively a first machining line width D1, a third machining line width D3, and a fourth machining line width D4, which are different from each other.

Operations constituting methods according to the disclosure may be performed in any suitable order unless otherwise indicated herein or otherwise clearly contradicted by context. The disclosure is not necessarily limited by the order of operations. The use of any and all examples or exemplary terms (for example, “such as”) provided herein is simply intended to describe the disclosure in detail, and the scope of the disclosure is not limited by the examples or exemplary terms unless otherwise claimed. In addition, it will be understood by those of ordinary skill in the art that various modifications, combinations and changes may be made according to design conditions and factors within the scope of the appended claims or equivalents thereof.

Therefore, it will be understood that the spirit of the disclosure should not be limited to the embodiments described above, and the claims and all equivalent modifications fall within the scope of the disclosure.

What is claimed is:

1. A laser machine for use in semiconductor device machining, the laser machine comprising:
at least one laser oscillator configured to output a laser beam;
at least one beam control element configured to control a shape of the laser beam output from the at least one laser oscillator;
at least one lens arranged between the at least one beam control element and a workpiece and configured to control a size of the laser beam, the shape of which is controlled by the at least one beam control element, and irradiate the size-controlled laser beam onto the workpiece; and
a controller configured to set a machining line width to be formed on the workpiece, determine a rotation angle of the at least one beam control element according to the set machining line width, and control the at least one beam control element to be rotated around a rotation axis parallel to a normal line of a plane of the workpiece according to the determined rotation angle.

2. The laser machine of claim 1, wherein the at least one beam control element comprises a one-dimensional diffractive optical element configured to split the laser beam into a plurality of branched beams in a one-dimensional array, and
the controller is further configured to determine the rotation angle, based on radii of curvature of branched beams having passed through the at least one lens and a gap between adjacent branched beams having passed through the at least one lens.

3. The laser machine of claim 2, wherein, in case that a parallel axis (Lt) parallel to a direction in which the plurality of branched beams are linearly arranged and a reference axis (As) parallel to a machining direction crossing the machining line width are defined, the rotation angle is selected within a range from 0°, which corresponds to a case where the parallel axis (Lt) is parallel to the reference axis (As), to an acute angle formed between the parallel axis (Lt) and the reference axis (As).

4. The laser machine of claim 1, wherein the at least one beam control element comprises a linear beam generation diffractive optical element or a cylindrical lens, each configured to control the laser beam into a linear beam.

5. The laser machine of claim 4, wherein, in case that a parallel axis (Lt) parallel to the linear beam and a reference axis (As) parallel to a machining direction crossing the machining line width are defined, the rotation angle is selected within a range from 0°, which corresponds to a case where the parallel axis (Lt) is parallel to the reference axis (As), to 90°, which corresponds to a case where the parallel axis (Lt) is perpendicular to the reference axis (As).

6. The laser machine of claim 1, further comprising a beam limiting element arranged between the at least one beam control element and the at least one lens and configured to block a portion of the laser beam, the shape of which is controlled by the at least one beam control element.

7. The laser machine of claim 6, wherein the beam limiting element comprises a slit or an aperture.

8. The laser machine of claim 6, wherein the controller is further configured to determine a beam blocking range, based on the rotation angle.

9. The laser machine of claim 1, wherein the at least one lens comprises an objective lens.

10. The laser machine of claim 9, wherein the controller is further configured to control a size of the machining line width by controlling magnification through changing a focal length of the at least one lens.

11. A laser machining method, performed by a laser machine for use in semiconductor device machining, of machining a workpiece, wherein the laser machine is configured to:
cause a laser oscillator to output a laser beam;
cause a beam control element to control a shape of the output laser beam; and
control a size of the laser beam, the shape of which is controlled by a lens, and irradiate the size-controlled laser beam onto the workpiece,
wherein a controller is configured to:
set a machining line width to be formed on the workpiece;
determine a rotation angle of the beam control element according to the set machining line width; and
control the beam control element to be rotated around a rotation axis parallel to a normal line of a plane of the workpiece according to the determined rotation angle.

12. The laser machining method of claim 11, wherein the beam control element comprises a one-dimensional diffractive optical element configured to split the laser beam into a plurality of branched beams in a one-dimensional array, and
the controller is further configured to determine the rotation angle, based on radii of curvature of branched beams having passed through the lens and a gap between adjacent branched beams having passed through the lens.

13. The laser machining method of claim 12, wherein, in case that a parallel axis (Lt) parallel to a direction in which the plurality of branched beams are linearly arranged and a reference axis (As) parallel to a machining direction crossing the machining line width are defined, the rotation angle is selected within a range from 0°, which corresponds to a case where the parallel axis (Lt) is parallel to the reference axis (As), to an acute angle formed between the parallel axis (Lt) and the reference axis (As).

14. The laser machining method of claim 11, wherein the beam control element comprises a linear beam generation diffractive optical element or a cylindrical lens, each configured to control the laser beam into a linear beam.

15. The laser machining method of claim 14, wherein, in case that a parallel axis (Lt) parallel to the linear beam and a reference axis (As) parallel to a machining direction crossing the machining line width are defined, the rotation angle is selected within a range from 0°, which corresponds to a case where the parallel axis (Lt) is parallel to the reference axis (As), to 90°, which corresponds to a case where the parallel axis (Lt) is perpendicular to the reference axis (As).

16. The laser machining method of claim 11, wherein a beam limiting element is arranged between the beam control element and the lens and configured to block a portion of the laser beam, the shape of which is controlled by the beam control element.

17. The laser machining method of claim 16, wherein the beam limiting element comprises a slit or an aperture.

18. The laser machining method of claim 16, wherein the controller is further configured to control the beam limiting element in synchronization with the rotation angle.

19. The laser machining method of claim 11, wherein the lens comprises an objective lens.

20. The laser machining method of claim 19, wherein the controller is further configured to control a size of the machining line width by controlling magnification through changing a focal length of the at least one lens.
